(19) United States
(12) Patent Application Publication
(10) Pub. No.: US 2015/0165555 A1
(43) Pub. Date: Jun. 18, 2015

(54) TUBE SEAM WELD STATION AND WELD SHOES

(71) Applicant: GLOBAL AUTOMOTIVE SYSTEMS, LLC, Auburn Hills, MI (US)

(72) Inventors: Cory J. Rivard, Algonac, MI (US); Stephen M. Saghy, II, New Baltimore, MI (US)

(21) Appl. No.: 14/568,745

(22) Filed: Dec. 12, 2014

Related U.S. Application Data
(60) Provisional application No. 61/915,743, filed on Dec. 13, 2013.

(51) Int. Cl. B23K 26/24; B23K 26/08

(52) U.S. Cl. CPC B23K 26/24; B23K 26/083

(57) ABSTRACT

A welding station includes a weld shoe with a tube contact surface adjacent to a seam being welded to control the height and/or location of the tube at the seam. This facilitates alignment of the edges of the tube before, during and after the edges are welded together. The shoe provides a reduced contact surface area that may reduce heat build-up and friction, as well as reduce the build-up of any coatings, like zinc, or contaminants on the shoe contact surface. Among other things, this extends the useful life of a shoe and/or its contact surface, and reduces the need to clean the contact surfaces, all of which reduce the downtime of the weld station. Production rates may also be increased, and the rate of rejected parts may be decreased.

### REFERENCE TO COPENDING APPLICATION

This application claims the benefit of U.S. Provisional Patent Application Ser. No. 61/915,743 filed Dec. 13, 2013, which is incorporated herein by reference in its entirety.

### TECHNICAL FIELD

The present disclosure relates to welding a seam in a metal tube.

### BACKGROUND

Sheet metal may be bent into a tubular shape and adjacent edges of the material welded together to define a closed tube. When a laser welding process is used, controlling the location and arrangement of the edges of material relative to the weld location is difficult due to a number of factors. These factors may include the springback/resiliency of the material forming the tube, build-up of contaminants and material spatter on the control surfaces and the tube at and downstream of the weld location, and friction and heat build-up within the control surfaces and the tube being welded. These issues reduce the rate at which the tube may be welded, and increase the downtime of a weld workstation to clean, repair or replace tube control surfaces that are fouled during the weld process. The issues also increase the rate at which welded tube is scrapped due to poor weld quality or damaged parts. And issues are especially problematic when the material being welded is a galvanized or otherwise coated or treated metal as the coating may spatter and build-up between the control surfaces and welded tube.

### SUMMARY

In at least one embodiment a welding station includes a weld shoe with a tube contact surface adjacent to a seam being welded to control the height and/or location of the tube at the seam. This facilitates alignment of the edges of the tube before, during and after the edges are welded together. The shoe provides a reduced contact surface area that may reduce heat build-up and friction, as well as reduce the build-up of any coatings, like zinc, or contaminants on the shoe contact surface. Among other things, this extends the useful life of a shoe and/or its contact surface, and reduces the need to clean the contact surfaces, all of which reduce the downtime of the weld station. Production rates may also be increased, and the rate of rejected parts may be decreased.

In at least one embodiment, a pair of weld shoes are provided with each weld shoe having a tube contact surface. Each contact surface is adapted and arranged to engage the tube adjacent a separate one of the two edges the define a seam in the tube. Each contact surface may be spaced from a bend in the tube and arranged to control the seam edges without flexing any bend in the tube to reduce springback of the material of the tube.

The weld shoes may include a back end relief including a recess downstream of the tube contact surface of each weld shoe. The back end relief may be provided inboard of a downstream end of the shoe and at, upstream or downstream of the weld location where a laser beam engages the tube. The relief reduces the build-up on the shoes of dust and other contaminants, such as metal and/or metal coating splatter that result from the welding process and may reduce heat transfer to the contact surfaces and shoes generally. In at least some applications, if the tube contact surface extended in the area of the relief, contaminants would build-up between the shoe and tube which could damage the tube and/or the weld due to the increased thickness of the shoe and/or require more frequent cleaning or repair of the shoes.

In one form, a laser welding apparatus includes a laser beam generator, a weld station and at least one weld shoe. The laser beam generator provides a laser beam onto a workpiece at a weld location. The weld station has an inlet side into which a workpiece to be welded is moved and an outlet side from which a welded portion of the workpiece is moved. At least one weld shoe is carried by the weld station and has a contact surface arranged to engage a portion of the workpiece upstream of the weld location to positively locate said portion of the workpiece for the welding operation. The contact surface may terminate at or upstream of the weld location. And a back end relief may be provided downstream of the contact surface and downstream of the weld location to provide an area where the workpiece is not contacted by the weld shoe downstream of the weld location.

In at least some implementations, a weld shoe for a laser welding workstation includes a body adapted to be mounted adjacent to a weld location. The body may have a contact surface extending from upstream of the laser weld location to engage and guide at least one surface of the workpiece to be welded. The contact surface may terminate at or upstream of the weld location. In at least some embodiments, a back end relief is provided adjacent to the contact surface and downstream of the weld location that provides an area wherein the weld shoe does not engage the workpiece. In other embodiments, the weld shoe may terminate at or near where the contact surface terminates.

In at least some implementations, a weld station has an inlet side into which a workpiece to be welded is moved and an outlet side from which a welded portion of the workpiece is moved. The weld station also includes a support, at least one roller and at least one weld shoe. The roller is carried by the support to guide and/or advance the workpiece within the weld station, and has a track in which a portion of the workpiece is received. The track has an upper edge against which a portion of an upper surface of the workpiece is received and where the upper surface of the workpiece includes a seam to be welded. At least one weld shoe is carried by the support and has a contact surface arranged to engage a portion of the workpiece upstream of the weld location to positively locate said portion of the workpiece for the welding operation. The contact surface may terminate at or upstream of the weld location. The shoe may also include a back end relief provided downstream of the contact surface and downstream of the weld location to provide an area where the workpiece is not contacted by the weld shoe downstream of the weld location.

Other embodiments can be derived from combinations of the above and those from the embodiments shown in the drawings and the descriptions that follow.

### BRIEF DESCRIPTION OF THE DRAWINGS

The following detailed description of preferred implementations and best mode will be set forth with regard to the accompanying drawings, in which:

FIG. 1 is a schematic view of a portion of a metal tube welding station showing a weld gun and a weld box that includes weld shoes adapted to control alignment of a seam of the tube as the seam is welded;

FIG. 2 is a plan view of the weld box;

FIG. 3 is a front view of the weld box;

FIG. 3A is an enlarged fragmentary view of the encircled portion 3A in FIG. 3;

FIG. 4 is a side view of a weld shoe;

FIG. 5 is a bottom view of the weld shoe of FIG. 4;

FIG. 6 is an end view of the weld shoe of FIG. 4;

FIG. 7 is a bottom view of a second weld shoe;

FIG. 8 is a side view of the weld shoe of FIG. 7;

FIG. 9 is an end view of the weld shoe of FIG. 7; and

FIG. 10 is fragmentary perspective and somewhat diagrammatic view of alternate shoes positioned adjacent to a workpiece.

### DETAILED DESCRIPTION OF PREFERRED EMBODIMENTS

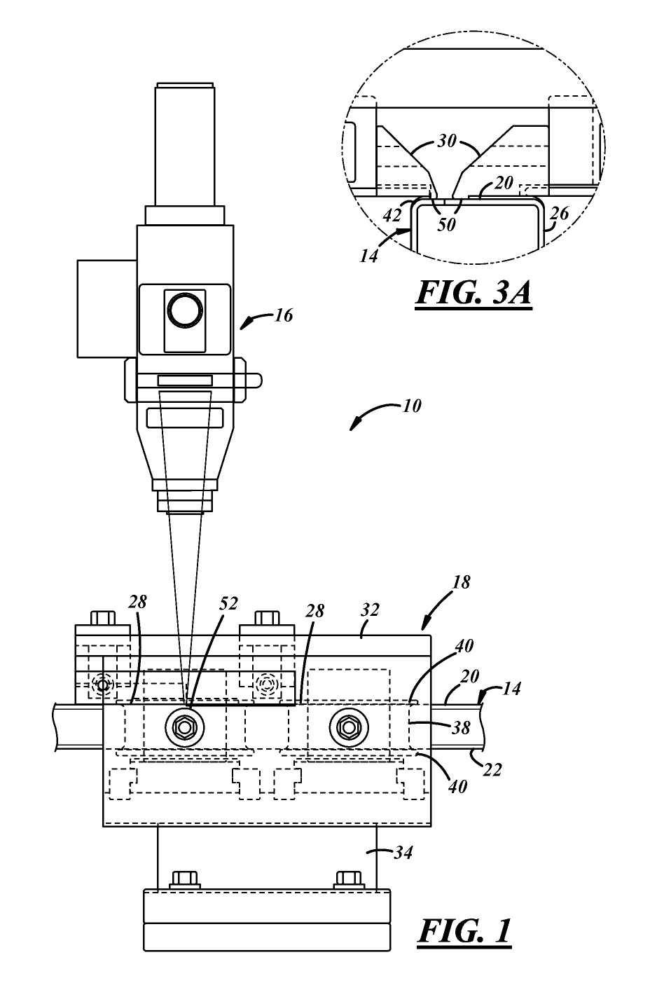

Referring in more detail to the drawings, FIGS. 1-3 and 3A illustrate a portion of a weld station 10 for welding a seam 12 of a workpiece 14. In the example shown, the workpiece includes a metal strip that has been formed into a tube 14 where adjacent edges 15 of the metal strip are welded together to define a closed tube. In the embodiment shown, the tube 14 is a rounded rectangle in cross-section and has generally planar upper and lower walls 20, 22 interconnected by opposed sidewalls 24, 26. In this example, the seam is provided in the upper wall 20, although that is not required and other orientations, arrangements, shapes, sizes, etc., are possible. The seam 12 is defined by the adjacent edges 15 and may be continuously welded by a laser beam generator 16 as the tube 14 passes through the weld station 10, which may include a workpiece and component support structure sometimes called a weld box 18.

The weld box 18 may include one or more final rollers 28, weld shoes 30, and a support 32 therefore. The support 32 may be rigidly mounted to a base 34 and provides accurate alignment and support for the rollers, weld shoes and/or other components. As shown, two pairs of rollers 28 are provided, each pair including a roller 28 adjacent to each sidewall 24, 26 of the tube 14. The rollers may include tracks 36 therein with a base 38 adapted to engage a tube sidewall 24 or 26 and spaced apart flanges 40 adapted to overlie a tube bend 42 and a portion of the upper and lower tube walls 20, 22. The rollers 28 in each pair are spaced apart a distance designed to firmly hold the tube 14 from opposed sides so that the sidewalls 24, 26 remain a desired distance apart. The rollers 28 in or at the weld box 18 may simply hold and guide the tube 14 as it moves through the weld station 10, they move drive or help drive the tube through the weld station, and/or they may perform some final bending of the material of the tube. As shown in FIG. 1, a first pair of rollers 28 may be provided at an inlet side 44 of the weld box 18 and the second pair of rollers 28 may be downstream of the first pair and closer to an outlet side 46 of the weld box 18 from which a welded portion of the workpiece (e.g. tube 14) extends. The welding operation, in the example shown, occurs at the second, downstream pair of rollers, although the laser 16 and its beam could be provided elsewhere. The terms downstream and upstream refer to the direction of movement through the weld box 18 of the tube 14.

The weld shoes 30 may be carried by the weld box 18 such as by supports 32 to which the weld shoes may be fixed. In the implementation shown, the weld shoes 30 have elongated, rigid metal bodies that are connected to the supports 32 of the weld box 18 by machine screws. The weld shoes 30 could also be clamped, or otherwise secured in place. The weld shoes 30 may extend generally parallel to the tube 14 and one weld shoe may be provided on each side of the seam 12.

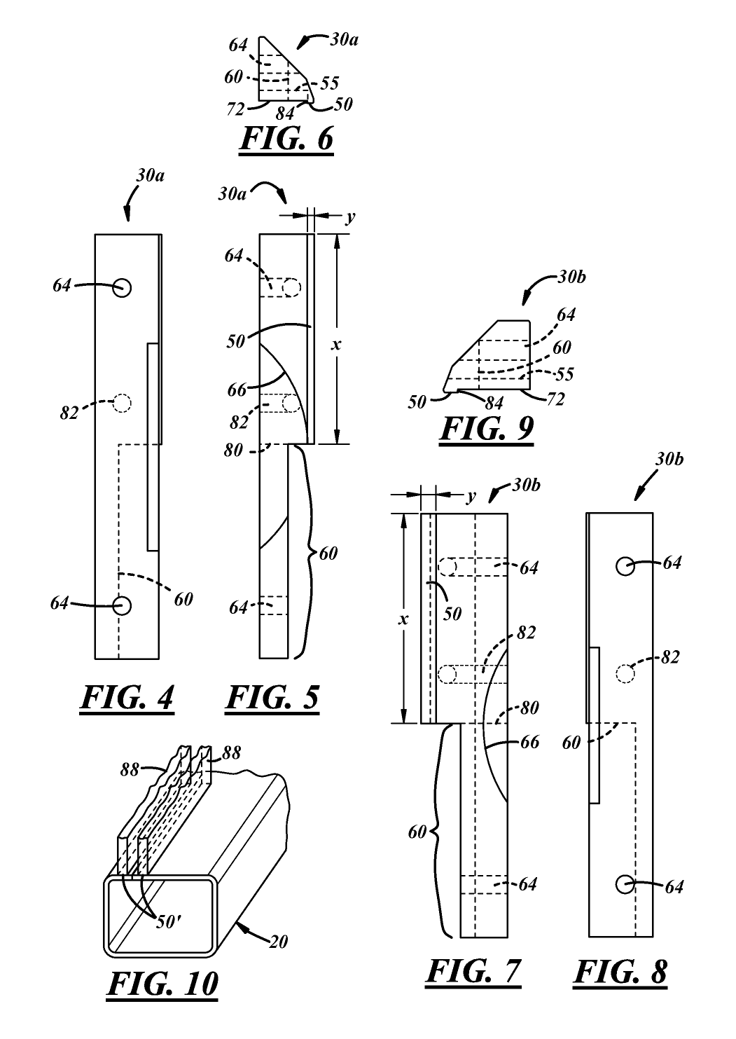

As shown in FIGS. 3, 6 and 9, each weld shoe 30 includes a contact surface 50 arranged to engage and position one edge 15 of the tube 14 before and as it is welded, with one contact surface 50 provided for each of the two edges 15 of the tube. The contact surface 50 of each shoe 30 has an upstream end located upstream of the weld location 52 (shown in FIG. 1, and is generally where the laser beam engages the tube 14 to form the weld), and a downstream end located adjacent to the weld location 52 and may be provided either just upstream, at, or just downstream of the weld location. Between the upstream and downstream ends, the contact surface 50 may be generally planar and arranged to be generally continuously engaged with the tube 14 between an edge 15 of the tube and a bend 42 between the adjacent sidewall 24 or 26 and the wall including the seam (in this implementation, it is the upper wall 20). FIGS. 4-6 illustrate a left-side weld shoe 30a and FIGS. 7-9 illustrate a right-side weld shoe 30b. The ‘a’ and ‘b’ designations are used only on FIGS. 4-9 and otherwise the weld shoes may be generally and collectively referred to by the reference numeral 30. Further, the designations “left-side” and “right-side” refer to the relative positions of the weld shoes as viewed from the inlet side 44 as in FIG. 3, and these designations are not intended to limit this disclosure.

The contact surfaces 50 have a length ‘x’ greater than their width ‘y’ and are oriented with their length generally parallel to the path of movement of the tube 14 through the weld station 10. To provide a desired engagement with the tube 14, the contact surfaces 50 may have a width ‘y’, measured in a direction perpendicular to the direction of travel of the tube 14, that is less than the distance between an adjacent edge 15 of tube on one side of the contact surface and the bend 42 on the other side of the contact surface. In at least certain implementations, the contact surface engages the tube at a location 0.5 mm or greater from the seam, and 0.5 mm or greater from a tangent point 53 of the bend 42, where the tangent point is at a transition between the bend 42 and the adjacent portion of the tube between the bend and the seam 12. The contact surfaces 50 are designed and arranged to control the location of the edges 15 of the tube 14 during the welding process. The contact surfaces 50 ensure that the edges 15 are adjacent to and aligned with each other in a desired orientation and position. In at least some forms, upstream of the shoes, the portion of the tube 14 that includes the edges may be angled toward the contact surfaces 50 to ensure that the contact surfaces engage the tube wall 20 to accurately and repeatedly align the edges 15 for welding. In other words, the contact surfaces are positively engaged with the tube wall 20 to ensure proper alignment of the tube edges 15. Or the contact surfaces 50 may be oriented to ensure engagement with the tube 14, as desired.

As shown in FIG. 10, the contact surfaces 50′ may be defined in any suitable structure such as, but not limited to, flat plates 88, rather than the shoes as shown in FIGS. 1-9. The position of the plates 88 or other contact surface structure may be adjustable to account for wear, different tube sizes, or the like. Further, the contact surfaces may be defined in a replaceable insert that is carried by another structure (e.g. bolted or otherwise removably connected thereto). This is generally shown by the dashed line 55 in FIGS. 6 and 9 and permits the insert to be removed for cleaning, repair, refurbishment or replacement, while the rest of the shoe or other structure may be used with a different insert coupled thereto. Different inserts made of different materials may be used in different applications, with different workpiece types, materials, etc. Any structure including a contact surface may be considered to be a weld shoe for the purposes of this patent application.

As shown in FIGS. 4-9, the contact surfaces 50 of the pair of weld shoes 30 do not extend the full length of the shoes 30. Instead, a back end relief 60 may be provided downstream of and generally aligned with the contact surfaces 50. The back end relief 60 may comprise a void or other absence of material to provide an open space for dust, spatter from the welding process and other contaminants to escape rather then become trapped between the weld shoes 30 and tube 14. The back end relief 60 could extend for the remainder of the shoe length, or for only a portion thereof with a secondary contact surface provided downstream of the relief 60 to engage the tube 14 adjacent to the welded seam. In at least some forms, the back end relief 60 starts upstream of the weld location (e.g. upstream of the laser beam) and continues to the downstream end of the weld shoe 30. Thus, the contact surfaces 50 terminate upstream of the laser and weld spatter and the like is inhibited or prevented from building up on the contact surfaces 50. Positive or negative pressure air flows may be used to reduce the likelihood that weld spatter and/or other weld generated contamination will engage the contact surfaces. Further, less heat may be transferred to the contact surfaces 50 and weld shoes 30 generally.

In the non-limiting implementation shown, the weld shoes 30 are longer than the diameter of the rollers 28, and are mounted to the weld box 18 via two holes 64 one provided on each side of the adjacent roller 28. The contact surfaces 50 may extend between about 10% and 100% of the length of the weld shoes 30, and are shown as extending about 50% of the length of the shoes in the non-limiting example shown. In at least some implementations, the contact surfaces 50 terminate at the weld spot to 4 mm upstream of the weld spot. In at least some implementations, the weld location 52 may be within about 1 mm of a line or plane including the centerline (i.e. axis of rotation) of the second pair of rollers 28, which is the location of the least distance between the rollers 28 and the point of greatest inward force or compression on the tube 14, at least with respect to the second pair of rollers. The contact surfaces may terminate at the line or plane including the centerline of the second pair of rollers up to about 4 mm upstream of that line or plane. Further, the contact surfaces may be, in at least certain embodiments, equal to or greater than 0.3 mm in height providing a step 84 (FIGS. 6 and 9) of that height. The shoes of any construction (including those shown in FIG. 10) may be adjustable height-wise to account for wear of the contact surfaces. This may extend the useful life of the shoe (or inserts that include the contact surfaces) and provide satisfactory control of the weld seam over that useful life even with wear of the contact surfaces.

The back-end relief may facilitate retrofitting a shoe to an existing weld box having attachment points for the shoe both upstream and downstream of the weld location. Instead of providing a back-end relief, the shoes may be shorter in length and may, if desired, be coextensive with the contact surfaces (or even shorter). This is generally shown in FIGS. 5 and 7 by the dashed lines 80 which show where the shoes may terminate, and by the fastener holes 82 shown in dashed lines which provide a second point of connection between the shoe and weld box (especially when the shoes terminate at 80) to prevent rotation or other movement of the shoe.

Cutouts 66 may also be provided to provide clearance between the weld shoes 30 and rollers 28. As shown in FIG. 3, the weld shoes 30 may be mounted so that the contact surfaces 50 are below an outer surface 68 (FIG. 3) of the adjacent rollers 28, and generally flush or coplanar with an upper edge 70 (FIG. 3) of the inner surface of the roller tracks 36. As shown, a portion of the upper edge 70 of the roller tracks 36 may engage a portion of the tube surface (e.g. upper wall 20) being welded, at a location spaced from the adjacent tube edge 15. In such an arrangement, the contact surface 50 engages the tube 14 between its edge 15 and the roller flange 40.

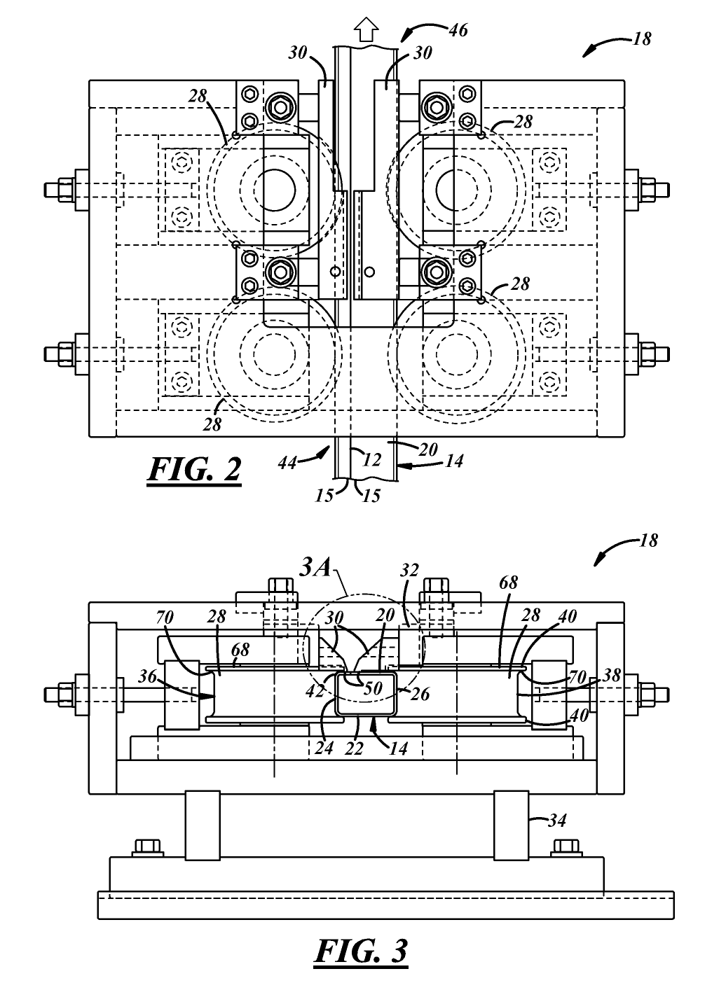

As further shown in FIGS. 2 and 3, the seam 12 may be provided offset from a centerline of the tube 14 such that the seam 12 is closer to one sidewall 24 or 26 than the other. Hence, the weld shoes 30 may be of different sizes, and the contact surfaces 50 may also be of different sizes, if desired. As shown, the weld shoe 30b on the right-hand side in FIG. 3 is wider than the weld shoe 30a on the left-hand side. Likewise, the contact surface 50 of the right-hand shoe 30b may be larger, while remaining between the adjacent edge and bend, than is the contact surface 50 of left-hand shoe 30a. In one non-limiting implementation, the right-hand shoe 30b is about 1.5 inches wide and its contact surface is 0.25 of an inch wide, while the left-hand shoe 30a is just over 1-inch wide and its contact surface is about 0.12 of an inch wide. Further, as shown in FIGS. 6 and 9, the contact surfaces 50 of each weld shoe 30 may extend downwardly from an adjoining lower surface 72 of the shoes.

The reduced contact surface area between the weld shoes 30 and the tube 14 can reduce friction and heat build-up between the shoes and tube and avoid stressing a bend/radius in the tube that may lead to undesirable springback after the weld is performed which may negatively affect part or weld quality. This reduced contact surface area may also reduce wear on the weld shoes 30 as well as reduce marring or other damage of the contacted surface of the tube 14. And the process speed may be increased to permit more tube to be welded over a given time. Further, the transfer to the weld shoes 30 of material from the tube (e.g. zinc or other coating) may be reduced. Still further, by terminating the shoe contact surfaces 50 at or just upstream of the laser beam interface (weld location) the transfer to the weld shoes 30 by spattering or otherwise of weld process byproducts and zinc or other coatings can be reduced or eliminated. Hence, the need to clean or otherwise service the weld shoes 30 is reduced which may reduce the downtime of the weld station 10 to improve the weld process efficiency. The scrap rate from the process is also reduced due to the decreased heat and friction, and the cleaner interface between the tube 14 and the weld shoe contact surfaces 50.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention. For example, relative location or orientation terms like upper, lower, side, top, bottom, left, right or the like are directed to the orientation of components in the drawings and are not intended to limit the invention unless expressly noted as such a limitation. It is contemplated that the components may be oriented and arranged in other ways.

1. A laser welding apparatus, comprising:
a laser beam generator providing a laser beam onto a workpiece at a weld location;
a weld station having an inlet side into which a workpiece to be welded is moved and an outlet side from which a welded portion of the workpiece is moved; and
at least one weld shoe carried by the weld station and having a contact surface arranged to engage a portion of the workpiece upstream of the weld location to positively locate said portion of the workpiece for the welding operation and wherein the contact surface terminates at or upstream of the weld location.

2. The apparatus of claim 1 wherein the contact surface ends within 4 mm of the weld location.

3. The apparatus of claim 1 wherein the workpiece includes a seam to be welded that is defined by an edge of the workpiece, a bend adjacent to the seam and a surface between the bend and the seam and wherein the contact surface is arranged to engage said surface between the bend and the seam and is narrower than the distance between the edge and a tangent point of the bend.

4. The apparatus of claim 1 wherein the contact surface has a width that is less than the width of the weld shoe, where the width is a dimension perpendicular to the direction of movement of the workpiece.

5. The apparatus of claim 1 wherein the workpiece includes a seam defined by adjacent edges of the workpiece and a pair of weld shoes are provided with one weld shoe adjacent to each edge of the workpiece.

6. The apparatus of claim 1 wherein the weld shoe includes a back end relief generally aligned with contact surface to provide an area of the workpiece that is not engaged by the weld shoe downstream of the weld location.

7. A weld shoe for a laser welding workstation having a laser beam at a weld location, the weld shoe adapted to contact a workpiece surface having a seam and a bend spaced from the seam, the weld shoe comprising:
a body adapted to be mounted adjacent to the weld location, the body having a contact surface extending from upstream of the weld location to engage and guide at least one surface of the workpiece to be welded and wherein the contact surface terminates at or upstream of the weld location.

8. The weld shoe of claim 7 wherein the contact surface ends within 4 mm of the weld location.

9. The weld shoe of claim 7 wherein the contact surface is arranged to engage said workpiece surface between the bend and the seam and is narrower than the distance between the seam and a tangent point of the bend.

10. The weld shoe of claim 9 wherein the contact surface is adapted to engage the workpiece at 0.5 mm or greater from the both the seam and the tangent point of the bend.

11. The weld shoe of claim 7 which includes a back end relief generally aligned with contact surface to provide an area of the workpiece that is not engaged by the weld shoe downstream of the weld location.

12. An apparatus, comprising:
a workpiece having a surface with a seam and a bend spaced from the seam;
a weld station having an inlet side into which the workpiece is moved, an outlet side from which a portion of the workpiece is moved and a weld location between the inlet and outlet sides where a weld is created at the seam of the workpiece, the weld station comprising:
a support;
at least one roller carried by the support to guide and/or advance the workpiece within the weld station, the roller having a track in which a portion of the workpiece is received and the track has an upper edge against which a portion of the workpiece is received and where that portion of the workpiece includes the seam;
at least one weld shoe carried by the support and having a contact surface arranged to engage said surface of the workpiece upstream of the weld location to positively locate said surface of the workpiece for the welding operation, and the contact surface terminates at or upstream of the weld location.

13. The weld station of claim 12 wherein the contact surface is disposed adjacent to the upper edge of the track and between the roller and seam of the workpiece.

14. The weld station of claim 12 wherein the contact surface is coplanar with at least a portion of the upper edge of the track.

15. The weld station of claim 12 wherein the weld shoe also includes a back end relief generally aligned with contact surface to provide an area of the workpiece that is not engaged by the weld shoe downstream of the weld location.

16. The weld station of claim 12 wherein the contact surface engages the workpiece surface at a location at least 0.5 mm from the seam and a tangent point of the bend.

17. The weld station of claim 12 wherein a pair of rollers are provided and each roller has an axis of rotation and the contact surface terminates at or up to 4 mm upstream of a plane including the axis of rotation of both rollers.

18. The weld station of claim 17 wherein the weld location is within 2 mm of the plan including the axis of rotation of both rollers.
